(19) United States
(12) Patent Application Publication
(10) Pub. No.: US 2008/0293809 A1
(43) Pub. Date: Nov. 27, 2008

(54) Pest control formulation

(75) Inventor: Donald W. Kelley, Athens, TX (US)

Correspondence Address: JACQUELINE S LARSON, 245 AVINGTON ROAD, ALAMEDA, CA, 94502, US

(73) Assignee: Redline, Inc.

(21) Appl. No.: 12/154,282

(22) Filed: May 21, 2008

Related U.S. Application Data
(60) Provisional application No. 60/931,080, filed on May 21, 2007.

(51) Int. Cl. A01N 53/06; A01N 25/32; A01P 15/00

(52) U.S. Cl. 514/520; 514/772

(57) ABSTRACT

The present invention relates to a pest control composition that includes a pest control active ingredient and a polyoxypropylene-polyoxyethylene ether of a long chain fatty alcohol as an agent to reduce or eliminate paraesthesia of the active ingredient to a warm blooded mammal. The system releases the active ingredient efficiently and uniformly. The pest control formulation is less irritating to the animal's skin as compared to prior art systems. The formulation is useful for making animal collars, ear tags, pest strips, liquid spot-on treatments, and the like.

This application claims the benefit of U.S. provisional patent application Ser. No. 60/931,080, filed May 21, 2007.

### FIELD OF THE INVENTION

The present invention relates to a pest control system that includes a pest control active ingredient and a polyoxypropylene-polyoxyethylene ether of a long chain fatty alcohol as an agent to reduce or eliminate paraesthesia of the active ingredient. The system releases the active ingredient efficiently and uniformly. The pest control system is less irritating to the animal's skin as compared to prior art systems. The system is useful for making animal collars, ear tags, pest strips, liquid spot-on treatments, and the like.

### BACKGROUND OF THE INVENTION

Many pest control active ingredients cause irritation (paraesthesia) to warm-blooded animals (including humans). This irritation to the skin and/or eyes of warm-blooded animals hampers the use of these pest control active ingredients. This irritation factor occurs even when the pest control active ingredient is blended with polymers or in other formulations (such as granules, dusts, dips, liquids, emulsions, etc.) wherein the active ingredient is considerably diluted.

The synthetic pyrethroid class of insecticides is known to cause paraesthesia when coming into contact with the skin, with differing degrees of paraesthesia being caused by different synthetic pyrethroids. Generally, the higher the degree of paraesthesia, the more active the pyrethroid is against various insects; and those having a cyano group in their molecular structure produce a greater degree of paraesthesia. While paraesthesia is a transitory phenomenon, higher degrees of paraesthesia have caused severe trauma to animals' skins when applied thereto and have required days for the pain to end and weeks for the skin to repair. Thus, it has prevented some of the most beneficial efficacious pyrethroids from being used on animals due to the unacceptable dermatological effects produced on the animal.

Efforts to prevent or reduce the paraesthesia effect of pyrethroids have been attempted with limited success. For example, vitamin E acetate has been cited in literature as an efficacious therapeutic agent for synthetic pyrethroid exposure. However, in formulating a product to be applied to an animal, particularly with the paraesthesia-producing pyrethroids, vitamin E has only a slight delaying of the paraesthesia effect.

U.S. Pat. No. 5,437,869 describes the use of triphenyl phosphate (TPP), a solid at room temperature, to reduce the paraesthesia phenomena. The more irritating the active, the higher the ratio of TPP is required. These ratios of TPP-to-active may be incorporated into a solid. However, when a liquid pest control system is required, a problem arises when a high level of active ingredient is also required. Due to the solubility characteristics of TPP (solid state of TPP at room temperature), a high percentage of highly irritating active does not leave room for a high ratio of TPP while remaining in liquid form at room temperature. Even a one-to-one ratio cannot be achieved in a liquid product and remain stable when a high level of active ingredient is required. For example, 50% active ingredient+50% TPP becomes a solid at room temperature. Additionally, in some applications it is desired to utilize a high level, up to sixty percent or more, of active ingredient and remain as a liquid in order to minimize the dose amount used in a single application. An animal spot-on product is an example of a need for a small dose amount of formulation measured in drops, which necessitates a high concentration of active agent in the formulation in order to obtain acceptable pest control.

International Pat. Pubin. WO 2004/086862 describes the use of isodecyl diphenyl phosphate (IDPP), which is a liquid, to reduce the paraesthesia effects of synthetic pyrethroids. IDPP is successful in reducing paraesthesia sufficiently to allow for the formulation of liquid spot-on products that are acceptable for large animals such as horses, large dogs, and the like. However, the paraesthesia is not completely eliminated, so that the IDPP-containing liquid products remain unacceptable for small animals such as puppies and small dogs.

It would be desirable to have a synthetic pyrethroid-containing product that not only reduces but actually eliminates paraesthesia, and to have a liquid synthetic pyrethroid-containing product that would be suitable for treatment of small animals.

### SUMMARY OF THE INVENTION

The present invention is directed to a method and a composition for the controlled delivery of a pest control active agent or a mixture of active agents while reducing or eliminating the irritation of the pest control active agent to warm blooded mammals. More particularly, the pest control system of the invention comprises a pest control formulation comprising a pest control active agent, one embodiment of which is a synthetic pyrethroid, and a polyoxypropylene-polyoxyethylene ether of a long chain fatty alcohol of formula (I) (also referred to herein and in the claims as the “ether component”):

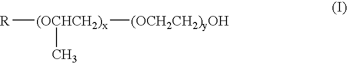

wherein, x is an integer between 3 and 10, y is an integer between 2 and 50, and R is a long chain fatty alcohol moiety.

The formulation may optionally include other ingredients as necessary or desired, depending on the particular active agent chosen and the form of the final product. Such optional ingredients can include, but are not limited to, system carriers such as polymers, clays, water, solvents, and the like; plasticizers; synergists; fragrances; coloring agents; preservatives; antioxidants; light stabilizers; and the like. The resulting pest control system may take the form of a solid, such as a polymer, granule, powder or dust; a liquid, such as a dip, a spray, or a spot-on; or an emulsion; as long as the pest control active agent and the ether component remain associated together as a group within the pest control system, such that the combination is maintained when released to the locus of treatment.

The present invention is further directed to a method for reducing or eliminating the irritation to warm-blooded animals of a liquid pest control active agent in a solid or liquid, preferably liquid, pest control system, the method comprising associating the ether component together with the active agent as a pre-blend and incorporating the pre-blend into the other ingredients, if any, of the pest control formulation, the amount of the ether component present being an amount effective to reduce the irritation of the active agent to warm blooded animals.

The system of the invention provides a non paraesthesia-producing stable formulation that may, in one embodiment, include a high percentage of the irritating active agent. This invention further allows for a high concentration of active agent, such as pyrethrins and synthetic pyrethroids, in a stable liquid formulation at room temperature, while reducing any irritation of the active agent. The formulation of the invention is effective without loss of the biological activity of the active agent. This invention is particularly useful for reducing or eliminating the irritation of synthetic pyrethroids to warm-blooded animals, including pet animals that are treated with the formulation for controlling insect pests and humans that handle and apply the formulation to the animals. This invention is further particularly useful when the pest control system is a liquid.

### DETAILED DESCRIPTION OF THE INVENTION

As used herein, “a” and “an” mean one or more, unless otherwise indicated.

“Paraesthesia” as used herein and in the appended claims is defined as primarily a condition that results in a feeling (burning, tingling, and/or pricking sensation) of the skin.

To “eliminate the parasthesia”, as used herein and in the appended claims, means that a formulation has a Paraesthesia Rating of <1 for up to at least 24 hours in the Human Ear Assay, as described in the Examples hereinbelow.

The pest control active agent may be chosen from any active agent known to be useful in the control of insect or acarid pests, such as but not limited to a natural or synthetic pyrethroid. The present invention is particularly useful for delivering pest control active agents that cause paraesthesia in warm-blooded animals, although the invention is not limited thereto. Synthetic pyrethroids are well-known to be irritating to animals. Thus, in a presently preferred embodiment of the present invention, the pest control active agents are selected from pyrethroids. However, any active agent that causes paraesthesia in animals is included within the present invention. The active agents may be liquids or solids at room temperature. While the invention is particularly useful for delivering liquid active agents at high concentrations in the formulation, the invention is not limited thereto but may also be used with active agents, either liquid or solid, at any concentration that results in the desired result of reducing or eliminating the paraesthetic effects of a paraesthesia-causing active agent while maintaining the active agent's insecticidal effects. One or more active agents may be included within the formulation of the present invention. Exemplary pesticides and repellents which are effective against horn flies, face flies, stable flies, house flies, mosquitoes, lice, ticks, and mites are pyrethrin, cypermethrin, decamethrin, cyhalothrin, flumethrin, cyfluthrin, fenvalerate, deltamethrin, fempropathrin, fluvalinate, flucythrinate, cyfluthrin, alphamethrin, tralomethrin, cycloprothrin, karate, cyphenothrin (Gokilaht™), or any synthetic pyrethroid with a cyano group in its molecular structure. Preferred pest control active agents are the pyrethrins and synthetic pyrethroids; more preferred are the synthetic pyrethroids and especially those that have a cyano group in their molecular structure.

Many of these active agents are effective both as a pesticide and a repellent, and the activity of many is enhanced by the inclusion of a synergist. Examples of suitable synergists include piperonyl butoxide and N-octyl bicycloheptene dicarboximide.

The ether component of the composition of the present invention is a polyoxypropylene-polyoxyethylene ether of a long chain fatty alcohol of formula (I) (also referred to herein and in the claims as the “ether component”):

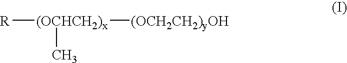

wherein, x is an integer between 3 and 10, including between 3 and 5; y is an integer between 2 and 50, including between 2 and 25; and R is a long chain fatty alcohol moiety, such as, for example, cetyl, myristyl, stearyl, and the like. One example of a material that is suitable is an ether of formula (I) wherein x has an average value of 5 and y has an average value of 20 and R is cetyl. A material of this type that is sold commercially is Procetyl AWS (PPG-5-Ceteth-20; Croda). Other commercially available materials which are suitable are Witconol APEM (PPG-3-Myreth-3), Witconol APES (PPG-9-Stearth-3), Stanamul OXL (PPG-10-Cetearth-20), and Procetyl AWS Modified (PPG-8-Ceteth-2).

The ether component of the composition is compatible with high concentrations (that is, of up to about 30 wt %, preferably up to about 40 wt %, more preferably up to about 50 wt % or more) of liquid active agents, including synthetic pyrethroids.

The amount of the ether component in the formulation relative to the amount of active agent will be an amount effective to reduce or eliminate the irritation caused by the active agent. The effective amount is easily determinable by routine experimentation. Generally, the amount of ether component in the formulation should be at least equal to the amount of active agent and, often, the amount of the ether component in the formulation is double to many times the amount of active agent in the formulation in order to reduce the irritation value of the active agent. Thus, the ratio of ether component:active agent is preferably from about 1:1 to about 99.9:0.1.

To prepare pest control systems according to the invention, the pest control active agent and the ether component are mixed together to form an active agent/carrier blend (the pre-blend). This pre-blend is then mixed with other ingredients as necessary or desired, depending on the particular active agent chosen and the form and intended use of the final product. The resulting formulation is then processed (and, if necessary, extruded or otherwise shaped) into the desired pest control system.

For example, if the pest control system is a shaped polymeric article (such as an animal collar, an ear tag, or a pest strip, for example), a polymer or copolymer conventionally employed in such articles (such as polymers and copolymers of vinyl monomers such as polyvinyl chloride, polyvinyl acetate, polyacrylates or the like, or other powdered polymers or copolymers) is mixed with plasticizers and/or stabilizers as necessary, as are known in the art or can be determined without undue experimentation. An ether component/active agent pre-blend is added to the polymer mixture and combined until a dry free-flowing mix is obtained. Depending on the polymer chosen, it may require a common practice of heating the polymer to expand the particle so as to accept the ether component/active agent pre-blend and remain a dry free-flowing blend. This mix is then fused together into the desired shape by extruding or molding at the proper temperature and pressure by standard methods known in the art. When the ether component/active agent combination is maintained as it is released from the article (which can be determined without undue experimentation), the paraesthesia of the active agent is reduced.

When the pest control system is a dust or powder, for example, the pest control ether component/active agent pre-blend is mixed together with and incorporated into (such as by absorption or adsorption) the appropriate mineral or cellulosic substrate carrier. The carrier may be selected from talc, waxes, corn starch, silica and silica derivatives, clay, diatomaceous earth, corn cob, peanut hulls, paper, and the like, as are known in the art. The dust or powder pest control system is such that it maintains the ether component/active agent combination as they are released from the system.

When a liquid pest control system is prepared, the pest control ether component/active agent pre-blend is mixed together with a suitable organic solvent, an aqueous solvent, or mixtures thereof. The liquid carrier is chosen such that the active agent and the ether component will remain associated together as a group in the resulting system, which can be determined by those skilled in the art without undue experimentation.

The following examples illustrate the practice of the present invention. Parts are given as percentages and temperature in degrees Fahrenheit unless otherwise noted. “RT” is room temperature.

### EXAMPLES

The human ear assay is capable of discriminating between the effects of various formulations. Rapid penetration of the active agent in the ear lobe as well as the presence of the inferior maxillary of the trigeminus nerve system of the ear lobe tend to increase the sensitivity of the assay. It has been determined that a total volume of 10 μL of a formulation with an active volume (%) adjusted to 4 μL of technical active and applied to a human ear lobe provides, over time, an acceptable method of rating the paraesthesia of formulations.

For purposes of evaluation of the discovery of this invention and to assist in determining the correct ratios of active agent to the polyoxypropylene-polyoxyethylene ether of a long chain fatty alcohol of formula (I), the following screening procedure was set up:
1. Different ratios of active ingredient to ether component are formulated for evaluation.
2. A 10 μL sample of formulation to be evaluated is pipetted onto the ear lobe and left physically undisturbed. The paraesthetic effect of this sample is evaluated within a 24-hour period.
3. The “Paraesthesia Rating” is taken at the following time intervals following application of the formulation: 15 min, 30 min, 45 min, 1 hour and each hour thereafter to 24 hours.
4. Irritation or sensitivity values are assigned according to the following scale (“Paraesthesia Rating”):
   0=no sensation
   1=slight sensation
   2=sensation/no discomfort
   3=noticeable sensation
   4=slight discomfort
   5=noticeable discomfort
   6=uncomfortable
   7=very uncomfortable
   8=moderate hurting
   9=hurting
   10=severe hurting

When formulating, each individual formulation must be evaluated for irritation due to the influence of different actives, additional ingredients (solvents, surfactants, and the like) and/or forms (solids, liquids, dust, emulsion, and the like), which evaluation can be performed by those skilled in the art using known methods without undue experimentation.

### Examples 1-8

Following the above procedure, various formulations were tested and their Paraesthesia Rating (“PR”) determined. Results are set out in Table 1, below, where the PR Rating is the highest irritation rating and the hour (during the course of 24 hours) at which that rating was observed.

TABLE 1

| | Ingredients (wt %) | | | | | | PR Rating | |
|---|---|---|---|---|---|---|---|---|
| Example | Gokilaht* | Nylar** | Bansect^{†} | ProcetylAWS | Isopar L^{#} | ethyl lactate | (@ hrs) | |
| 1 | 100 | — | — | — | — | — | 10 | (8 hr) |
| 2 | 42.33 | — | — | — | 57.67 | — | 7 | (8 hr) |
| 3 | 40.0 | — | — | — | — | 60.0 | 7 | (6 hr) |
| 4 | 42.33 | — | — | 57.67 | — | — | <1 | (24 hr) |
| 5 | 42.33 | 4.20 | — | 53.47 | — | — | <1 | (24 hr) |
| 6 | 52.9 | — | — | 47.1 | — | — | <1 | (24 hr) |
| 7 | 0.105 | — | — | 99.895 | — | — | <1 | (24 hr) |
| 8 | — | — | 100 | — | — | — | 3 | (9 hr) |

*Gokilaht ™ Technical 94.5% (d-cyphenothrin; synthetic pyrethroid); available from MGK Company.
**Nylar ® insect growth regulator comprises approx. 50 wt % pyriproxyfen and approx. 50 wt % corn oil; available from MGK Company.
^{†}Bansect ® Squeeze-On (permethrin (40.0%); does not include cyano radical); available from Sergeant's Pet Care Products.
^{#}Isopar L ™ comprises predominantly C₁₁-C₁₃ isoparaffinic hydrocarbons; available from Exxon.

What is claimed is:

1. A pest control system comprising a pest control formulation that comprises a pest control active agent and a polyoxypropylene-polyoxyethylene ether of a long chain fatty alcohol of formula (I): 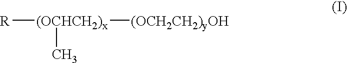
wherein,
x is an integer between 3 and 10,
y is an integer between 2 and 50, and
R is a long chain fatty alcohol moiety;
wherein the polyoxypropylene-polyoxyethylene ether of a long chain fatty alcohol is present in an amount effective to reduce or eliminate the paraesthesia of the active agent, and wherein the active agent and the polyoxypropylene-polyoxyethylene ether of a long chain fatty alcohol remain together in association in the system.

2. A pest control system according to claim 1 wherein in formula (I) x is an integer between 3 and 5, y is an integer between 2 and 25, and R is cetyl, myristyl, or stearyl.

3. A pest control system according to claim 1 wherein in formula (I) x is 5, y is 20, and R is cetyl.

4. A pest control system according to claim 1 wherein the amount of polyoxypropylene-polyoxyethylene ether of a long chain fatty alcohol is at least equal to the amount of active agent.

5. A pest control system according to claim 1 wherein the active agent is a synthetic pyrethroid.

6. A pest control system according to claim 5 wherein the synthetic pyrethroid is present in an amount of at least 1 wt %.

7. A pest control system according to claim 5 wherein the synthetic pyrethroid is present in an amount of from about 1 wt % to about 60 wt %.

8. A pest control system according to claim 5 wherein the synthetic pyrethroid is present in an amount of at least 30 wt %.

9. A pest control system according to claim 5 wherein the amount of polyoxypropylene-polyoxyethylene ether of a long chain fatty alcohol is at least equal to the amount of synthetic pyrethroid.

10. A pest control system according to claim 1 which is a liquid.

11. A method for eliminating the irritation to a warm blooded mammal of a pest control active agent in a solid or liquid pest control formulation, the method comprising:
preparing an ether component/active agent pre-blend by mixing together the active agent and a polyoxypropylene-polyoxyethylene ether of a long chain fatty alcohol of formula (I): 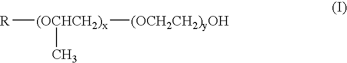
wherein,
x is an integer between 3 and 10,
y is an integer between 2 and 50, and
R is a long chain fatty alcohol moiety;
wherein the polyoxypropylene-polyoxyethylene ether of a long chain fatty alcohol is present in an amount effective to eliminate the paraesthesia of the active agent; and
incorporating the resulting ether component/active agent pre-blend into the other ingredients of the pest control formulation, such that the ether component and the active agent remain together in association in the formulation.

12. A method according to claim 11 wherein the amount of the polyoxypropylene-polyoxyethylene ether of a long chain fatty alcohol is at least equal to the amount of active agent.

13. A method according to claim 11 wherein the pest control formulation is a liquid.

14. A method according to claim 13 wherein the active agent is a synthetic pyrethroid.

15. A method according to claim 14 wherein the amount of the polyoxypropylene-polyoxyethylene ether of a long chain fatty alcohol is at least equal to the amount of synthetic pyrethroid.

16. A method according to claim 14 wherein the synthetic pyrethroid is present in an amount of from about 1 wt % to about 60 wt %.

17. A method according to claim 14 wherein the synthetic pyrethroid is present in an amount of at least 30 wt %.
